(19) United States
(12) Patent Application Publication
(10) Pub. No.: US 2002/0066473 A1
(43) Pub. Date: Jun. 6, 2002

(54) Solar collector washing system

(76) Inventors: Gil Levy, Tel Aviv (IL); Michael Gefen, Moshav Bney Zion (IL)

Correspondence Address: DR. MARK FRIEDMAN LTD., BILL POLKINGHORN DISCOVERY DISPATCH, 9003 FLORIN WAY, UPPER MARLBORO, MD, 20772, US

(21) Appl. No.: 09/726,584

(22) Filed: Dec. 1, 2000

(51) Int. Cl. B08B 3/02

(52) U.S. Cl. 134/34; 134/198

(57) ABSTRACT

The present invention is a system for, and a method of automatic washing of solar collection panels from dust, sediment, and the like, which tend to accumulate over time. The solar collector washing system comprises: (a) a solar collector having a solar collecting surface, the collector disposed in an angled position; (b) a water pipe mounted substantially above the solar collecting surface, the water pipe having a plurality of holes distributed along a length of the pipe for distribution of water onto the solar collecting surface, and (c) a control mechanism, operatively connected to said pipe, for releasing the water supply.

### FIELD AND BACKGROUND OF THE INVENTION

The present invention relates to a system for, and a method of, washing solar collectors.

Solar collectors are commonly used for heating water or air in buildings. There are two types of solar heating, passive and active. Passive heating relies on architectural design to heat buildings. The site, structure, and materials of a building can all be utilized to maximize the heating effect of the sunlight falling on it, thereby lowering or even eliminating the fuel requirement. A well-insulated building with a large glass window facing south, for instance, can effectively trap heat on sunny days and reduce reliance on gas or oil or electricity. Entering sunlight warms the air and the solid surfaces in those rooms exposed to it, and this warmth is carried to other rooms in the building by natural convection. Interior finishes such as brick or tile are often incorporated into buildings to absorb the sunlight and reradiate the heat at night.

In active heating, mechanical means are used to store, collect, and distribute solar energy in buildings in order to provide hot water or space heating. The sunlight falling on a collector panel of a building is converted to heat, which is transferred to a carrier fluid (usually a liquid, less commonly air) that is then pumped to a conversion, storage, and distribution system. In liquid-based systems, water (or less commonly glycol) is made to flow through tubes that are in contact with a flat-plate collector. The flow may be achieved by pumping, or by natural currents caused by the decreasing specific gravity of water with increasing temperature. The collector is a blackened metal plate that absorbs sunlight and is insulated on the front with layers of glass and air; the glass allows visible light to fall on the plate but traps the resulting heat, which is then transferred to the carrier fluid. Alternatively, the fluid may be pumped through an evacuated glass tube or a volume of space onto which a large volume of sunlight has been focused (and hence concentrated) by reflecting mirrors.

After picking up heat from the collector, the carrier fluid is pumped down to an insulated storage tank, where it can be used immediately or stored for later use. The system can supply a home with hot water drawn from the storage tank, or, with the warmed water flowing through tubes in floors, walls and ceilings, the system can provide space heating. The storage tank allows water heated during sunny periods to be used at night or during cloudy days. If the carrier fluid contains antifreeze to keep it from freezing during cold weather, a heat exchanger is used to transfer the heat of the carrier fluid to water that can be used for domestic purposes. Residential heating systems using flat-plate collectors typically heat carrier fluids to temperatures between 65° C. and 90° C.

The advantages of solar power are manifest: free, unlimited, non-polluting source of energy. However, active solar-energy systems such as those described above tend to be capital intensive with respect to heating systems utilizing conventional (usually fossil) fuels. In addition, the performance of solar-energy systems is heavily dependent on climatic conditions. As a result, solar-energy systems usually require a supplementary, conventional heating unit, which further increases the capital costs associated with such systems. Thus, in order to compete effectively with heating systems that utilize conventional (usually fossil) fuels, solar-energy systems must be sufficiently efficient to overcome such inherent drawbacks.

One major cause of inefficiency in solar-energy units is the clouding of the solar panels with dust and sediment. The most important mode of heat transfer to the pipes is radiative heat transfer from the sun. Even a small amount of dust and the like, dispersed on the surface of the solar panel, can drastically reduce the energy radiated from the sun directly to the pipes in the solar panel. Moreover, in many climates in which solar energy has particular potential, there is substantially no rain over the entire hot season (as much as 6-8 months, or practically never in extreme arid climates), such that dirty solar collectors are not cleaned by rain. Even in many rainy areas, the rainwater itself leaves a residue on the solar collector surface, such that collector performance does not approach the maximal level.

Finally, it must be emphasized that solar panels are generally mounted on a roof, preferably a sloped roof, making access for routine cleaning impractical, difficult, and often dangerous.

It must be emphasized that no prior art for washing solar collection panels exist in the field, except the inconvenient, rather dangerous method of manual washing by a flexible hose.

There is therefore a recognized need for, and it would be highly advantageous to have, a system for, and a method of, cleaning such solar panels, in which the cleaning is performed automatically, and in a simple and efficient manner.

### SUMMARY OF THE INVENTION

The present invention is a system for, and a method of automatic washing of solar collection panels from dust, sediment, and the like, which tend to accumulate over time. The solar collector washing system comprises: (a) a solar collector having a solar collecting surface, the collector disposed in an angled position; (b) a water pipe mounted substantially above the solar collecting surface, the water pipe having a plurality of holes distributed along a length of the pipe for distribution of water onto the solar collecting surface, and (c) a control mechanism, operatively connected to the pipe, for releasing the water supply.

According to another aspect of the present invention there is provided a method of washing a solar collector comprising the steps of: (a) providing a system including: a water pipe substantially mounted substantially above a solar collecting surface, the water pipe having a plurality of holes distributed along a length of the pipe for distributing water on the solar collecting surface, the pipe connected to a water supply; a control mechanism for releasing a supply of water, and (b) releasing the supply of water onto a solar collecting surface via the pipe.

According to further features in the described preferred embodiments, the control mechanism is designed and configured to operate according to a predetermined criterion.

According to still further features in the described preferred embodiments, the control mechanism is an electrically activated control valve.

According to still further features in the described preferred embodiments, the control mechanism is an electrically-controlled valve responsive to a microprocessing unit (MPU).

According to still further features in the described preferred embodiments, the control mechanism is a hydro-mechanical unit.

According to still further features in the described preferred embodiments, the hydro-mechanical unit includes: (a) a water tank having an inlet and an outlet; (b) a pivoted T-shaped element having a floating arm connected to the water tank by a pivot; and (c) a stopper arm making up a base of the T-shaped element and connected to the floating arm, the stopper arm having a detachably attached seal for blocking the outlet when the tank is in a filling state.

According to still further features in the described preferred embodiments, the predetermined criterion includes a time-duration.

According to still further features in the described preferred embodiments, the predetermined criterion is a time-interval.

According to still further features in the described preferred embodiments, the predetermined criterion is a date.

According to still further features in the described preferred embodiments, the solar collector washing system further comprises: (d) a timer for setting the predetermined criterion.

According to still further features in the described preferred embodiments, the timer is a mechanical timing unit.

According to still further features in the described preferred embodiments, the timer is an electrical timing unit.

According to still further features in the described preferred embodiments, the timer is associated with a microprocessing unit (MPU).

According to still further features in the described preferred embodiments, at least one of the holes is a nozzle.

According to still further features in the described preferred embodiments, the inlet includes a drip-emitter.

According to still further features in the described preferred embodiments, the drip-emitter is designed and configured to emit a substantially constant flow.

According to still further features in the described preferred embodiments, the solar collector washing system further comprises a wiping unit including a wiper, the wiper contacting the solar collecting surface.

According to still further features in the described preferred embodiments, the wiping unit is activated by the MPU.

According to still further features in the described preferred embodiments, the method further comprises: (c) filling a water tank to a predetermined level to provide the supply.

According to still further features in the described preferred embodiments, when the predetermined water level is attained, a floating arm in the tank is lifted, opening thereby an outlet in the tank through which the releasing the supply of water is effected.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1a shows a system for washing solar collectors, according to the present invention, having an electric valve and an MPU;

FIG. 1b is a schematic illustration of a water washing line according to the present invention, mounted above a solar collector;

FIG. 2 illustrates a system for washing solar collectors having a hydro-mechanical control mechanism.

### DESCRIPTION OF THE PREFERRED EMBODIMENTS

The present invention is a system for and a method of automatically cleaning of solar collection panels from dust, sediment, and the like, which tend to accumulate over time.

The principles and operation of the system and method according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

As used herein in the specification and in the claims section that follows, the term MPU refers to a microprocessor unit.

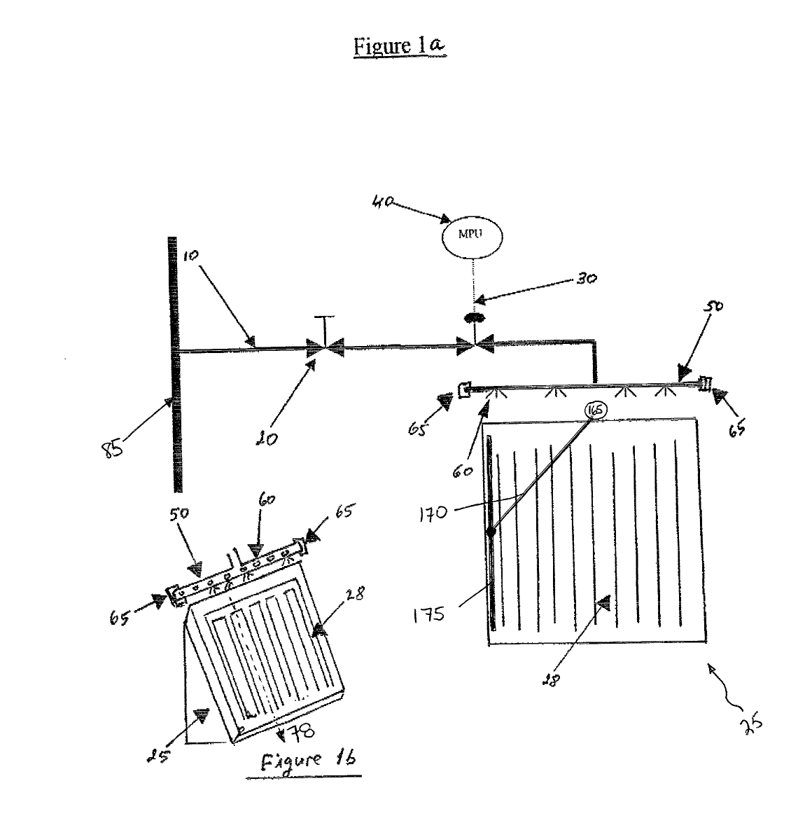

Referring now to the drawings, FIG. 1 shows a system for washing solar collectors. The system includes a water washing line 50, mounted above the uppermost edge of a solar collector 25. Water washing line 50 is sufficiently long to wash the entire width of solar collector 25. Holes 60, disposed along the length of water washing line 50, provide outlets for the water to flow on to surface 28 of solar collector 25.

One major cause of inefficiency in solar-energy units is the clouding of solar panels with dust, debris, sediment or deposits. Even a small amount of dust and the like, dispersed on the solar collection surface 28, can drastically reduce the energy radiated from the sun directly to the pipes in the solar panel. Efficient washing is vital for proper functioning of the solar collector. In the system for, and the method of washing the solar collector 25 of this invention, water flowing down on the surface 28 of the angled collector 25 washes down the dust, debris and sediments accumulated on the surface 28 and also dissolves any soluble deposits, thus improving the energy efficiency of the solar collector.

Various shapes are suitable for holes 60, including round, oval, and rectangular geometries. The holes may also be slit shaped. According to a preferred embodiment, holes 60 are fitted with nozzles, for improved washing of solar collector surface 25.

Water washing line 50 is fed by water flowing from the main water system 85 through a feed line 10, a manual valve 20, installed for maintenance purposes, and an electrically activated valve 30, which is normally closed. The feed line 10 can be connected to washing line 50 at an intermediate position. This requires washing line 50 to have two sealed ends 65. Alternatively (not shown), feed line 10 can be connected to washing line 50 at one end of washing line 50, with the distal end being sealed. Washing water is released by a control mechanism that opens electrically activated valve 30 according to a predetermined criterion, as will be described in further detail below.

According to a further embodiment the holes 60 are nozzles that improve the distribution of the water on the collection surface 28, thus improving the washing efficiency.

In a preferred embodiment, electrically actuated valve 30 Is directly activated by a timer (mechanical or electric), or through a microprocessing unit (MPU) 40, as well as other devices known to those skilled in the art, according to at least one predetermined criterion (e.g., time interval, date, etc.). The duration of the washing step can also be controlled using the above-mentioned devices according to a specified parameter (by sustaining valve 30 in an open position for a given amount of time or until achieving a given cumulative flow) and according to standard practice in the art. Electrically actuated valve 30 and MPU 40 are preferably designed to be operated by means of DC batteries or by a suitable AC/DC electric converter.

In a preferred embodiment, the washing system further includes a wiping unit. The wiping unit includes a wiper 175, a motor 165, and an arm 170 connecting wiper 175 to motor 165. Preferably, motor 165 operates at 24 V, and is operatively connected to MPU 40, such that the wiping unit is activated solely during the duration of each washing period.

FIG. 1b is a schematic illustration of water washing line 50 according to the present invention, mounted above a solar collector 25. Solar collector 25 is mounted such that solar collection surface 28 is disposed at an angle, as is generally practiced in the art to absorb as much solar radiation as possible. This disposition at an angle is utilized by the present invention to enhance the washing effect along the downward slope 78 of solar collection surface 28.

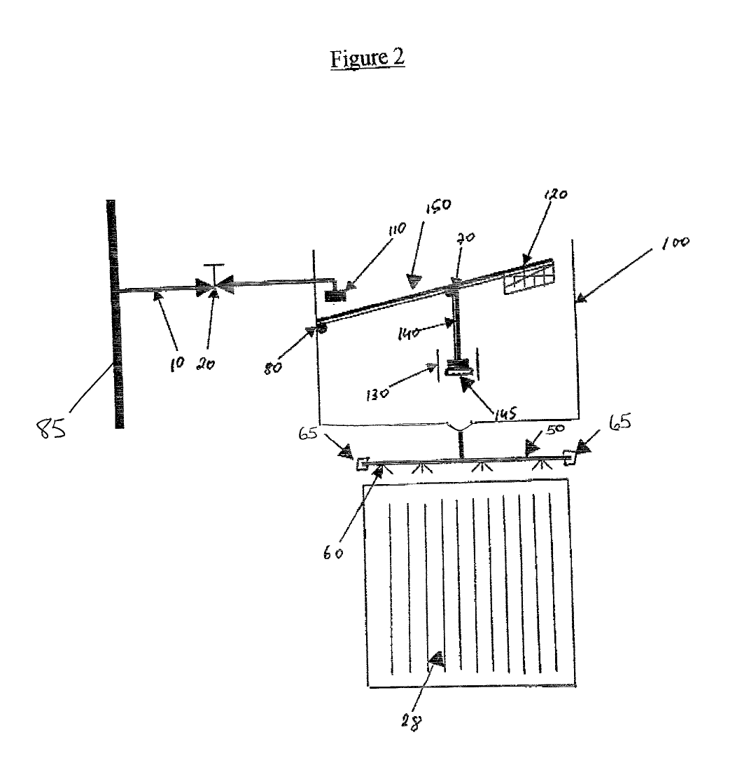

According to another aspect of the present invention, provided in FIG. 2, water-washing line 50 is fed by a hydro-mechanical system 200, which obviates the need for electrical components. Hydro-mechanical system 200 includes a water tank 100 with a capacity of at least one washing, typically 5-30 liters, according to the size of solar collector 25, and the environmental conditions, washing frequency, etc.

A pivoted, T-shaped element 150 having a floating arm 120 is connected to water tank 100 at a first end of the T by a pivot 80 that enables floating arm 120 to float according to the water level in water tank 100. A stopper arm 140 making up the base of the T is connected to floating arm 120 by means of a pivot 70. The movement of stopper arm 140 is substantially limited by a hollow, cylindrical guide 130 to a vertical up and down motion through guide 130. In a down position, a seal 145 positioned at the base of stopper arm 140 closes an opening 105 at the bottom of water tank 100. When water tank 100 has been filled to a requisite fill level, floating arm 120 is lifted by the water, thereby lifting stopper arm 140 and seal 145, such that opening 105 at the bottom of water tank 100 is exposed. Consequently, water in water tank 100 drains into water washing line 50, and flows through holes 60 disposed along the length of water washing line 50 and on to the surface of solar collector 25, as described above.

A water feed line 10 receiving water from the main water system 85 leads to water tank 100. Preferably, water feed line 10 is equipped with manual maintenance valve 20.A small opening 110 towards the end of water 20 feed line 10 allows water to slowly drip into water tank 100, such that the fill time (which in this case determines the time interval between washings) for water tank 100 is slow, typically within the range of 2-30 days, depending on the application.

Small opening 110 is preferably a standard, low-flow rate drip emitter. More preferably, small-opening 110 is a drip emitter having a flow rate that is substantially insensitive to water line pressure. An example of such a drip emitter is provided in U.S. Pat. No. 4,653,695 to Eckstein, which is incorporated by reference for all purposes as if fully set forth herein.

As used herein and in the claims section that follows, the term “predetermined criterion” refers to a parameter, set in advance, that provides the basis for activating a valve (e.g., electrically actuated valve 30 and/or another releasing device, such that wash water for the solar collection surface is released. Without wishing to be limited by specific examples, a typical predetermined criterion is absolute time (i.e., date, date/hour/minute, etc.) or time interval (e.g., every 3 weeks). In the above-described hydro-mechanical system,one predetermined criterion is the fill time of water tank 100, which is generally determined by the fill level inside water tank 100 and the flowrate from small opening 110 into water tank 100.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A solar collector washing system comprising:
(a) a solar collector having a solar collecting surface, said collector disposed in an angled position;
(b) a water pipe mounted substantially above said solar collecting surface, said pipe having a plurality of holes distributed along a length of said pipe for distribution of a water supply onto said solar collecting surface, and
(c) a control mechanism for releasing said water supply, said control mechanism operatively connected to said pipe.

2. The solar collector washing system of claim 1, wherein said control mechanism is designed and configured to operate according to a predetermined criterion.

3. The solar collector washing system of claim 1, wherein said control mechanism is an electrically activated control valve.

4. The solar collector washing system of claim 2, wherein said control mechanism is an electrically-controlled valve responsive to a microprocessing unit (MPU).

5. The solar collector washing system of claim 1, wherein said control mechanism is a hydro-mechanical unit.

6. The solar collector washing system of claim 5, wherein said hydro-mechanical unit includes:
(d) a water tank having an inlet and an outlet;
(e) a pivoted T-shaped element having a floating arm connected to said water tank by a pivot; and
(f) a stopper arm making up a base of said T-shaped element and connected to said floating arm, said stopper arm having a detachably attached seal for blocking said outlet when said tank is in a filling state.

7. The solar collector washing system of claim 2, wherein said predetermined criterion includes a time-duration.

8. The solar collector washing system of claim 2, wherein said predetermined criterion includes a time-interval.

9. The solar collector washing system of claim 2, wherein said predetermined criterion includes a date.

10. The solar collector washing system of claim 2, further comprising:
(d) a timer for setting said predetermined criterion.

11. The solar collector washing system of claim 10, wherein said timer is a mechanical timing unit.

12. The solar collector washing system of claim 10, wherein said timer is an electrical timing unit.

13. The solar collector washing system of claim 10, wherein said timer is associated with a microprocessing unit (MPU).

14. The solar collector washing system of claim 1, wherein at least one of said holes is a nozzle.

15. The solar collector washing system of claim 6, wherein said inlet includes a drip-emitter.

16. The solar collector washing system of claim 15, wherein said drip-emitter is designed and configured to emit a substantially constant flow.

17. The solar collector washing system of claim 4, further comprising:
(d) a wiping unit including a wiper, said wiper contacting said solar collecting surface.

18. The solar collector washing system of claim 17, wherein said wiping unit is activated by said MPU.

19. A method of washing a solar collector comprising the steps of:
(a) providing a system including:
(i) a water pipe substantially mounted substantially above a solar collecting surface, said water pipe having a plurality of holes distributed along a length of said pipe for distributing water on said solar collecting surface, said pipe connected to a water supply;
(ii) a control mechanism for releasing a supply of water, and
(b) releasing said supply of water onto a solar collecting surface via said pipe.

20. The method of claim 19, wherein said releasing is controlled by a control mechanism according to at least one predetermined criterion.

21. The method of claim 19, wherein said releasing is effected by activating an electrically actuated control valve by a microprocessing unit (MPU).

22. The method of claim 19, further comprising:
(c) filling a water tank to a predetermined level to provide said supply.

23. The method of claim 22, wherein when said predetermined level is attained, a floating arm in said tank is lifted, opening thereby an outlet in said tank through which said releasing said supply of water is effected.
